(19) United States
(12) Patent Application Publication
(10) Pub. No.: US 2019/0204621 A1
(43) Pub. Date: Jul. 4, 2019

(54) PROGRESSIVE LENS AND PROGRESSIVE GLASSES USING THE SAME

(71) Applicant: HON HAI PRECISION INDUSTRY CO., LTD., New Taipei (TW)

(72) Inventor: WEN-KAI LI, New Taipei (TW)

(21) Appl. No.: 16/018,180

(22) Filed: Jun. 26, 2018

(30) Foreign Application Priority Data
Dec. 29, 2017 (CN) 201711481226.8

(51) Int. Cl. G02C 7/06; A63B 33/00

(52) U.S. Cl. CPC G02C 7/061; A63B 33/002

(57) ABSTRACT

A progressive lens has an optical center and a geometric center line. The progressive lens further comprises a first surface and a second surface. At least one of the first surface and the second surface is a free-form surface. The free-form surface comprises a nearsight region, a farsight region, and a transition region. The geometric center line passes through the nearsight region, the optical center, and the farsight region. A straight-line distance between a first reference point of the nearsight region and the optical center along a direction of the geometric center line is about 13 mm to about 25 mm. A straight-line distance between a second reference point of the farsight region and the optical center along a direction of the geometric center line is about 2 mm to about 5 mm. The disclosure also provides a progressive glasses.

### FIELD

The subject matter herein generally relates to a progressive lens and a progressive glasses using the progressive lenses.

### BACKGROUND

Spectacle lenses are not only used for vision correction (such as nearsightedness, farsightedness, astigmatism, and presbyopia), but also used for eye protection and eye decoration. One person may use more than one spectacle lens in daily life. For example, for an elderly person who has both nearsightedness and presbyopia problems, the person may need a presbyopia spectacle lens to focus clearly on close objects, while distant objects appear blurry. The person may also need a nearsightedness spectacle lens to focus clearly on distant objects.

Frequently changing between different spectacle lenses is inconvenient. Customizing a spectacle lens involves a high cost. Improvements in the art are preferred.

### BRIEF DESCRIPTION OF THE DRAWINGS

Implementations of the present technology will now be described, by way of example only, with reference to the attached figures.

FIG. 1 is a diagram of an embodiment of a progressive lens.

FIG. 2 is a diagram showing a free-form surface of the progressive lens of FIG. 1 comprising a nearsight region, a farsight region, and a transition region.

FIG. 3 is a diagram of the progressive lens of the example 1, showing the contour plots of a refractive power of a free-form surface of the progressive lens of FIG. 2.

FIG. 4 is a diagram of the progressive lens of the example 1, showing the contour plots of an astigmatism of a free-form surface of the progressive lens of FIG. 2.

FIG. 5 is a diagram of the progressive lens of the example 2, showing the contour plots of a refractive power of a free-form surface of the progressive lens of FIG. 2.

FIG. 6 is a diagram of the progressive lens of the example 2, showing the contour plots of an astigmatism of a free-form surface of the progressive lens of FIG. 2.

FIG. 7 is a diagram of the progressive lens of the example 3, showing the contour plots of a refractive power of a free-form surface of the progressive lens of FIG. 2.

FIG. 8 is a diagram of the progressive lens of the example 3, showing the contour plots of an astigmatism of a free-form surface of the progressive lens of FIG. 2.

FIG. 9 is a diagram of an embodiment of a progressive glasses with two progressive lenses of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

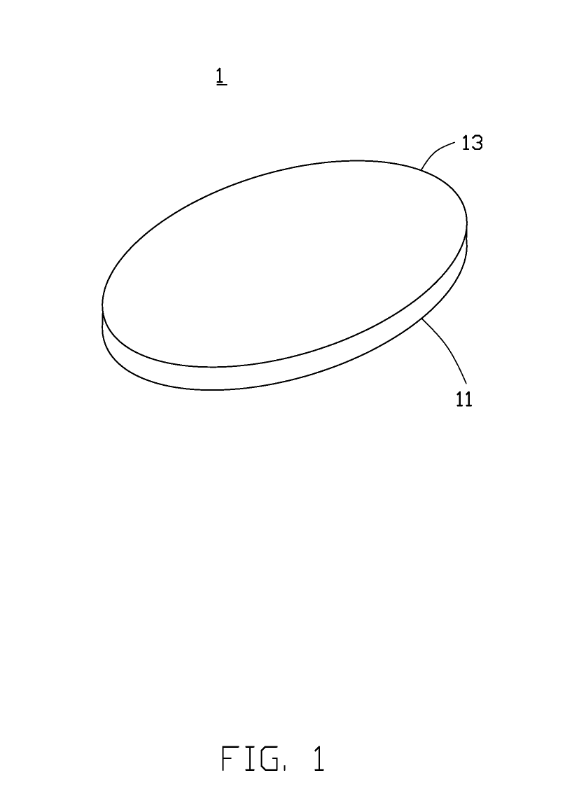

FIG. 1 illustrates an embodiment of a progressive lens 1. The progressive lens 1 comprises a first surface 11 and a second surface 13 facing away from the first surface 11. At least one of the first surface 11 and the second surface 13 is a free-form surface. In at least one embodiment, the free-form surface is a complex non-rotatable symmetrical surface.

In at least one embodiment, the first surface 11 is a free-form surface, and the second surface 13 is a spherical surface. In another embodiment, the second surface 13 is an aspherical surface.

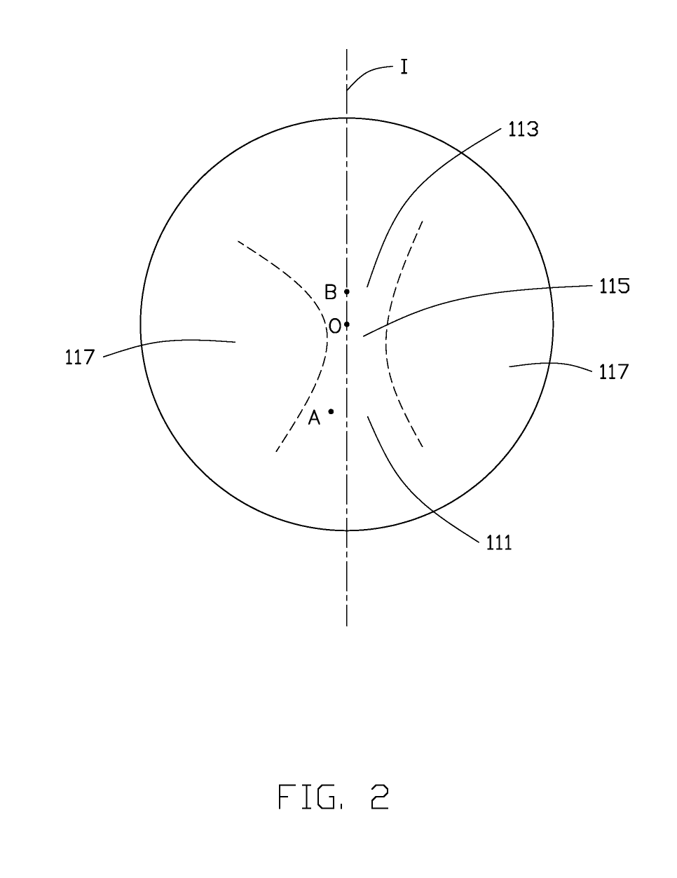

Referring to FIG. 2, the free-form surface comprises a nearsight region 111 having a refracting power corresponding to a near view, a farsight region 113 having a refracting power corresponding to a distant view, a transition region 115, and two astigmatism regions 117. The nearsight region 111 is positioned at a lower portion of the progressive lens 1. The farsight region 113 is positioned at an upper portion of the progressive lens 1. The transition region 115 is positioned in an intermediate portion of the progressive lens 1, and connects the nearsight region 111 and the farsight region 113. A refracting power of the lens gradually changes in the transition region 115. The astigmatism regions 117 are positioned at sides of the transition region 115. The nearsight region 111, the farsight region 113, and the transition region 115 form an effective visual area of the progressive lens 1.

The progressive lens 1 has an optical center (labeled as “O”) and a geometric center line (labeled as “I”) along a vertical direction. The geometric center line passes through the nearsight region 111, the optical center O, and the farsight region 113. The nearsight region 111 has a first reference point (labeled as “A”), and the farsight region 113 has a second reference point (labeled as “B”).

The farsight region 113 has a refractive power of about −8.0 D to about 0 D. The progressive lens 1 has an addition power of about 0 D to about +3.5 D. The progressive lens 1 has an astigmatic power of about −3.5 D to about 0 D.

The transition region 115 has a length of about 15 mm to about 30 mm. A narrowest portion of the transition region 115 has a width of about 2 mm to about 7 mm.

The first reference point of the nearsight region 111 has a visual width of about 10 mm to about 35 mm. The second reference point of the farsight region 113 has a visual width of about 10 mm to about 35 mm.

A straight-line distance between the first reference point of the nearsight region 111 and the optical center along a direction of the geometric center line is about 13 mm to about 25 mm. A straight-line distance between the second reference point of the farsight region 113 and the optical center along a direction of the geometric center line is about 2 mm to about 5 mm. A straight-line distance between the first reference point of the nearsight region 111 and the second reference point of the farsight region 113 along a direction perpendicular to the geometric center line is about 0.2 mm to about 2 mm. In at least one embodiment, the second reference point of the farsight region 113 is positioned on the geometric center line.

A user can have a clear view in the distance and a clear view in the vicinity through the progressive lens 1 without changing the lens. Also, the free-form surface is designed to enhance the comfort of wearing and alleviate eye fatigue some users find when using progressive lenses.

In at least one embodiment, the progressive lens 1 may be made of polycarbonate, polymethyl methacrylate, cyclic block copolymer, or other materials.

In another embodiment, the progressive lens 1 may further comprise at least one functional layer, such as anti-scratch layer, anti-reflective layer, anti-fog layer, anti-dust layer, waterproof layer, ultraviolet filtering layer, blue light filtering layer, and so on.

### Example 1

In the example 1 of the progressive lens 1, the straight-line distance between the first reference point of the nearsight region 111 and the optical center along a direction of the geometric center line is about 13 mm. The straight-line distance between the second reference point of the farsight region 113 and the optical center along a direction of the geometric center line is about 3 mm. The straight-line distance between the first reference point of the nearsight region 111 and the second reference point of the farsight region 113 along a direction perpendicular to the geometric center line is about 1.4 mm. The farsight region 113 has a diopter of about +0 D. The progressive lens 1 has an addition power of about +1.0 D. The progressive lens 1 has an astigmatic power of about 0 D. The transition region 115 has a length of about 16 mm. The narrowest portion of the transition region 115 has a width of about 3.5 mm. The first reference point of the nearsight region 111 has a visual width of about 32.81 mm. The second reference point of the farsight region 113 has a visual width of about 14.20 mm.

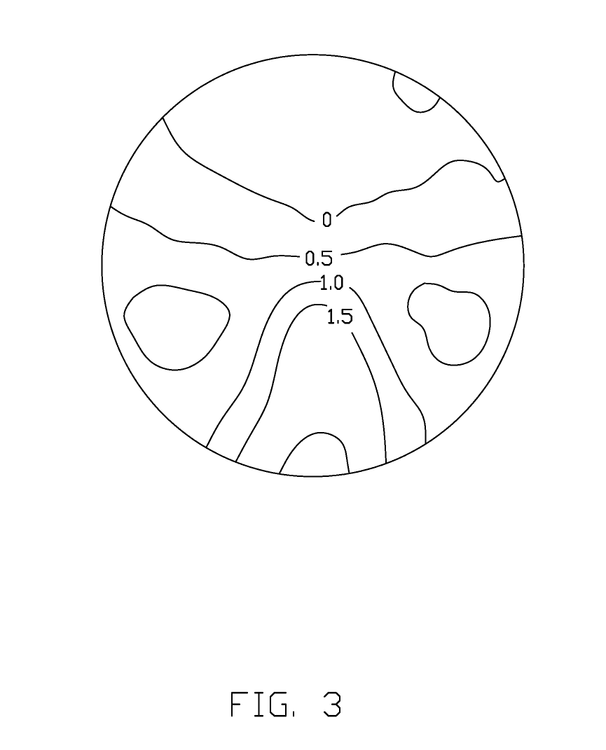

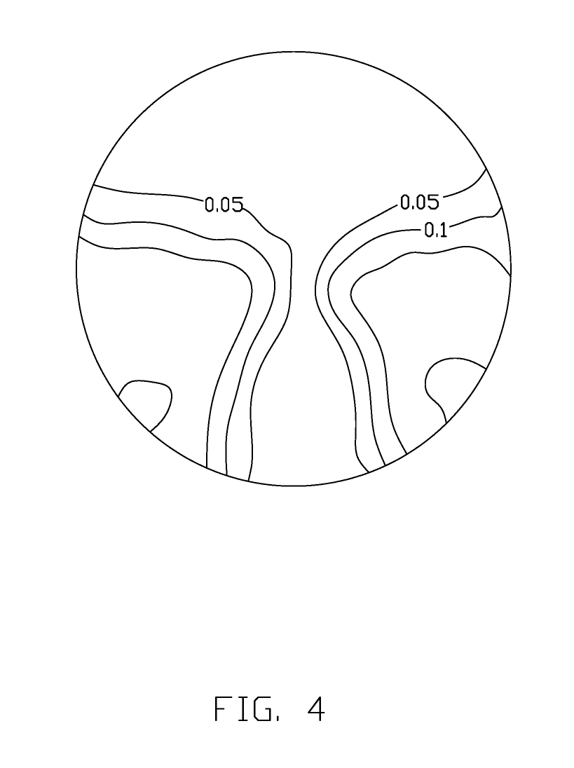

Contour plots of the refractive power of the free-form surface of the example 1 are shown in FIG. 3. Contour plots of an astigmatism of the free-form surface of the example 1 are shown in FIG. 4.

### Example 2

In the example 2 of the progressive lens 1, the straight-line distance between the first reference point of the nearsight region 111 and the optical center along a direction of the geometric center line is about 13.7 mm. The straight-line distance between the second reference point of the farsight region 113 and the optical center along a direction of the geometric center line is about 3.2 mm. The straight-line distance between the first reference point of the nearsight region 111 and the second reference point of the farsight region 113 along a direction perpendicular to the geometric center line is about 1.4 mm. The farsight region 113 has a diopter of about −2.0 D. The progressive lens 1 has an addition power of about +1.5 D. The progressive lens 1 has an astigmatic power of about 0 D. The transition region 115 has a length of about 16.5 mm. The narrowest portion of the transition region 115 has a width of about 3 mm. The first reference point of the nearsight region 111 has a visual width of about 32 mm. The second reference point of the farsight region 113 has a visual width of about 13.4 mm.

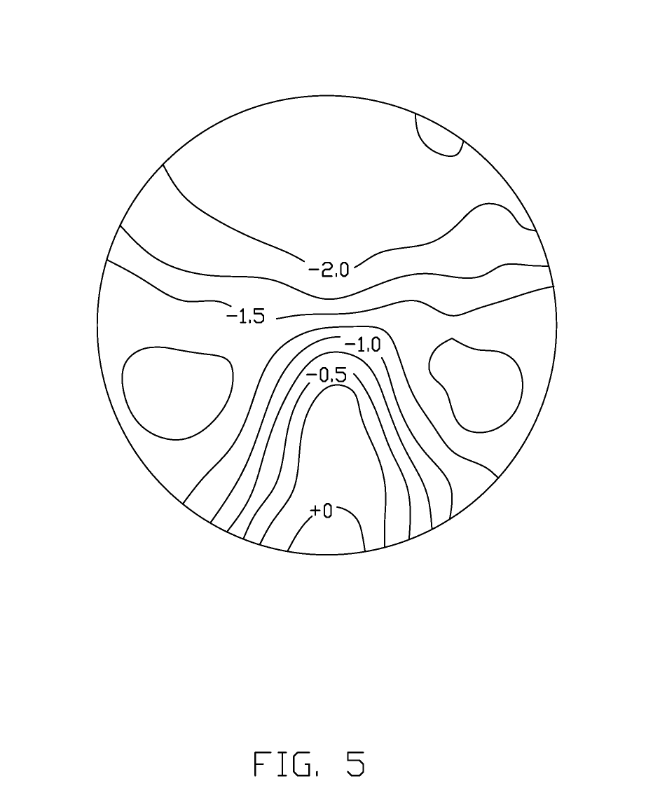

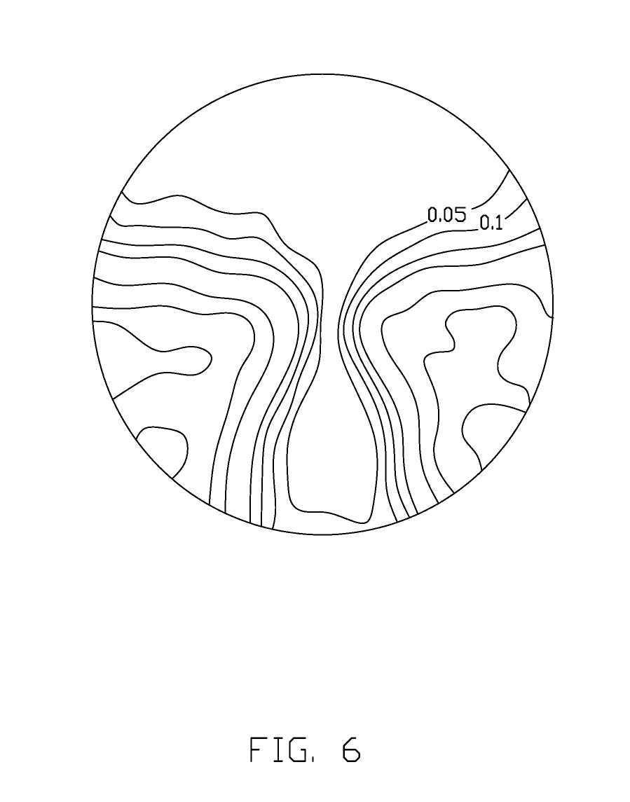

Contour plots of the refractive power of the free-form surface of the example 2 are shown in FIG. 5. Contour plots of an astigmatism of the free-form surface of the example 2 are shown in FIG. 6.

### Example 3

In the example 3 of the progressive lens 1, the straight-line distance between the first reference point of the nearsight region 111 and the optical center along a direction of the geometric center line is about 13.2 mm. The straight-line distance between the second reference point of the farsight region 113 and the optical center along a direction of the geometric center line is about 3.5 mm. The straight-line distance between the first reference point of the nearsight region 111 and the second reference point of the farsight region 113 along a direction perpendicular to the geometric center line is about 1.4 mm. The farsight region 113 has a diopter of about −2.5 D. The progressive lens 1 has an addition power of about +2.0 D. The progressive lens 1 has an astigmatic power of about 0 D. The transition region 115 has a length of about 16.8 mm. The narrowest portion of the transition region 115 has a width of about 3 mm. The first reference point of the nearsight region 111 has a visual width of about 31 mm. The second reference point of the farsight region 113 has a visual width of about 12.8 mm.

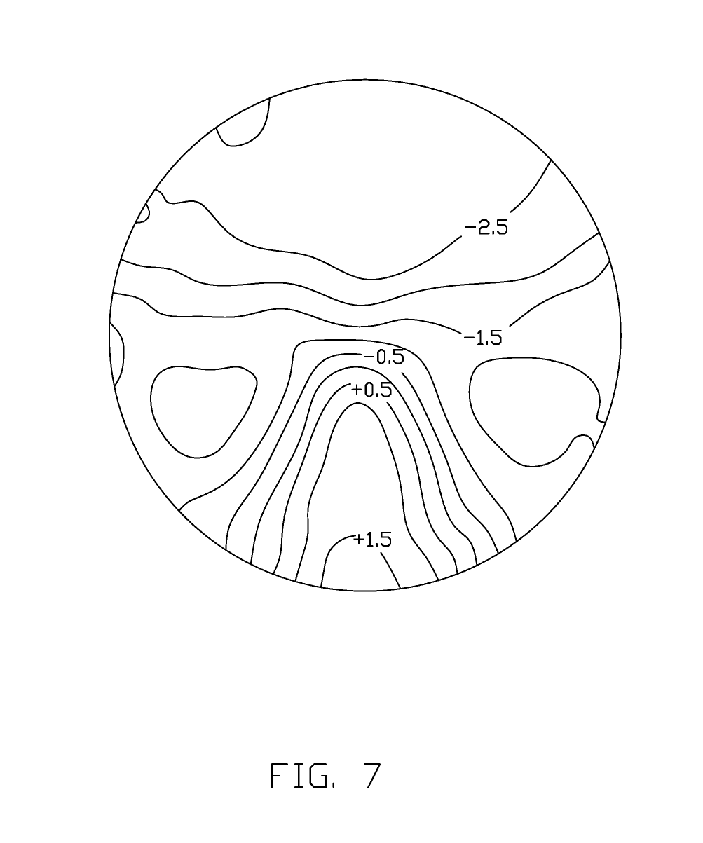

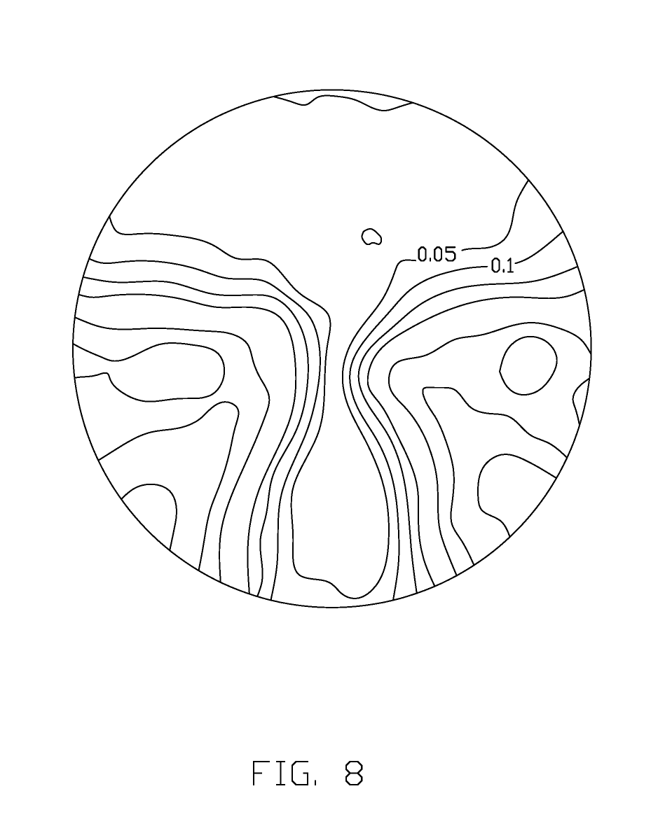

Contour plots of the refractive power of the free-form surface of the example 3 are shown in FIG. 7. Contour plots of an astigmatism of the free-form surface of the example 3 are shown in FIG. 8.

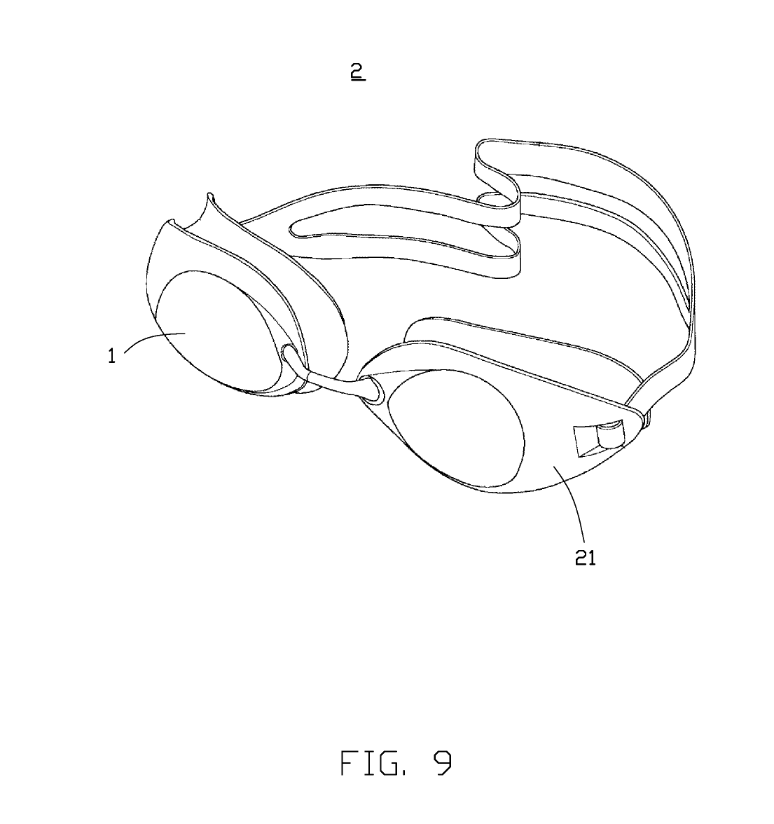

FIG. 9 illustrates an embodiment of a progressive glasses 2. The progressive glasses 2 comprise a glasses frame 21 and two spaced-apart progressive lenses 1 installed on the glasses frame 21. In at least one embodiment, the progressive glasses 2 can be glasses for underwater use, such as swimming goggles. The progressive lenses 1 are designed to meet the needs of water sports (such as swimming). The progressive lenses 1 can reduce visual disparities caused by water when used in the water, to allow the user to have a clearer vision in the water.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A progressive lens comprising:
a first surface;
a second surface opposite from the first surface;
an optical center; and
a geometric center line;
wherein at least one of the first surface and the second surface is a free-form surface, the free-form surface comprises a nearsight region positioned at a lower portion of the progressive lens, a farsight region positioned at an upper portion of the progressive lens, and a transition region positioned in an intermediate portion of the progressive lens, the transition region connects the nearsight region and the farsight region, the geometric center line passes through the nearsight region, the optical center, and the farsight region, the nearsight region has a first reference point, and the farsight region has a second reference point, a straight-line distance between the first reference point and the optical center along a direction of the geometric center line is about 13 mm to about 25 mm, a straight-line distance between the second reference point and the optical center along a direction of the geometric center line is about 2 mm to about 5 mm.

2. The progressive lens of claim 1, wherein a straight-line distance between the first reference point and the second reference point along a direction perpendicular to the geometric center line is about 0.2 mm to about 2 mm.

3. The progressive lens of claim 1, wherein the farsight region has a refractive power of about −8.0 D to about 0 D, the progressive lens has an addition power of about 0 D to about +3.5 D, and the progressive lens has an astigmatic power of about −3.5 D to about 0 D.

4. The progressive lens of claim 1, wherein the first reference point has a visual width of about 10 mm to about 35 mm.

5. The progressive lens of claim 1, wherein the second reference point has a visual width of about 10 mm to about 35 mm.

6. The progressive lens of claim 1, wherein the transition region has a length of about 15 mm to about 30 mm.

7. The progressive lens of claim 1, wherein a narrowest portion of the transition region has a width of about 2 mm to about 7 mm.

8. The progressive lens of claim 1, wherein the second reference point of the farsight region is positioned on the geometric center line.

9. A progressive glasses comprising:
a glasses frame; and
two spaced-apart progressive lenses mounted on the glasses frame, each progressive lens comprising:
a first surface;
a second surface facing away from the first surface;
an optical center; and
a geometric center line;
wherein at least one of the first surface and the second surface is a free-form surface, the free-form surface comprises a nearsight region positioned at a lower portion of the progressive lens, a farsight region positioned at an upper portion of the progressive lens, and a transition region positioned in an intermediate portion of the progressive lens, the transition region connects the nearsight region and the farsight region, the geometric center line passes through the nearsight region, the optical center, and the farsight region, the nearsight region has a first reference point, and the farsight region has a second reference point, a straight-line distance between the first reference point and the optical center along a direction of the geometric center line is about 13 mm to about 25 mm, a straight-line distance between the second reference point and the optical center along a direction of the geometric center line is about 2 mm to about 5 mm.

10. The progressive glasses of claim 9, wherein a straight-line distance between the first reference point and the second reference point along a direction perpendicular to the geometric center line is about 0.2 mm to about 2 mm.

11. The progressive glasses of claim 9, wherein the farsight region has a refractive power of about −8.0 D to about 0 D, the progressive lens has an addition power of about 0 D to about +3.5 D, and the progressive lens has an astigmatic power of about −3.5 D to about 0 D.

12. The progressive glasses of claim 9, wherein the first reference point has a visual width of about 10 mm to about 35 mm.

13. The progressive glasses of claim 9, wherein the second reference point has a visual width of about 10 mm to about 35 mm.

14. The progressive glasses of claim 9, wherein the transition region has a length of about 15 mm to about 30 mm.

15. The progressive glasses of claim 9, wherein a narrowest portion of the transition region has a width of about 2 mm to about 7 mm.

16. The progressive glasses of claim 9, wherein the second reference point of the farsight region is positioned on the geometric center line.
